(19) United States
(12) Patent Application Publication
(10) Pub. No.: US 2018/0366713 A1
(43) Pub. Date: Dec. 20, 2018

(54) INSULATING PROTECTOR AND ELECTRICITY STORAGE MODULE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Osamu Nakayama, Yokkaichi, Mie (JP); Naoki Fukushima, Yokkaichi, Mie (JP); Katsushi Miyazaki, Yokkaichi, Mie (JP); Seishi Kimura, Yokkaichi, Mie (JP)

(21) Appl. No.: 16/061,766

(22) PCT Filed: Feb. 14, 2017
(86) PCT No.: PCT/JP2017/005238

§ 371 Date: Jun. 13, 2018

(30) Foreign Application Priority Data
Feb. 17, 2016 (JP) 2016-027684

(51) Int. Cl. H01M 2/34; H01M 2/10; H01M 2/20; H01R 4/70

(52) U.S. Cl. CPC H01M 2/34; H01R 4/70; H01M 2/206; H01M 2/1016

(57) ABSTRACT

An insulating protector that is to be attached to an electricity storage module that has positive and negative electrode terminals, the insulating protector including: a main cover portion that is configured to allow a first bus bar that is connected to an electrode terminal, to be led out, and to allow a second bus bar that is connected to an electrode terminal, to be led out via a path that is different from a path via which the first bus bar is led out; and a sub cover portion that is pivotable about a hinge portion relative to the main cover portion, and covers the bus bar.

### CROSS-REFERENCE TO RELATED APPLICATIONS

This application is the U.S. national stage of PCT/JP2017/005238 filed Feb. 14, 2017, which claims priority of Japanese Patent Application No. 2016-027684 filed on Feb. 17, 2016, which is incorporated herein by reference in its entirety.

### FIELD OF THE INVENTION

The present description discloses technology related to an insulating protector.

### BACKGROUND OF THE INVENTION

In an electricity storage module of an electric vehicle, a hybrid vehicle, or the like, electrode terminals that are adjacent to each other, of a plurality of electricity storage elements, each having positive and negative electrode terminals, are connected to each other by bus bars, and thus the plurality of electricity storage elements are connected in series or in parallel.

In JP2000-149909A, a battery connection plate, in which a plurality of bus bars are embedded in a substrate part that is made of a synthetic resin, is attached to a battery assembly that includes a plurality of rectangular batteries. Electrodes that are adjacent to each other, of the plurality of rectangular batteries are connected to each other by the bus bars of the battery connection plate, and thus the plurality of rectangular batteries are connected in series. Covers that are openable and closable are connected to the substrate part of the battery connection plate with hinges.

### SUMMARY OF THE INVENTION

It is envisaged that bus bars that are to be connected to electrodes may be desired to be connected to different paths depending on the locations of connection paths between a plurality of batteries and the locations of external devices or the like that are to be connected to the electrodes at the ends of the series connection. In the battery connection plate according to JP2000-149909A, a plurality of bus bars are fixed at predetermined positions relative to a plurality of electrodes, and thus one predetermined connection path is formed by the bus bars. Therefore, if the bus bars are desired to be connected so as to form a different path, a new battery connection plate with a different shape needs to be prepared, which causes manufacturing costs to increase.

The technology disclosed in the present description has been completed in view of the above-described situation, and aims to provide an insulating protector with which bus bars can be connected to a plurality of paths, while suppressing an increase in manufacturing costs.

The technology disclosed in the present description is an insulating protector that is to be attached to an electricity storage module that has positive and negative electrode terminals, the insulating protector including: a main cover portion that is configured to allow a bus bar that is connected to an electrode terminal, to be led out, and to allow a bus bar that is connected to an electrode terminal, to be led out via a path that is different from a path via which the aforementioned bus bar is led out; and a sub cover that is pivotable about a hinge portion relative to the main cover portion, and covers a bus bar.

With this configuration, the sub cover portion pivots about the hinge portion relative to the main cover portion, and thus the sub cover portion can cover a bus bar that is connected to an electrode terminal via a different path. Therefore, there is no need to prepare different insulating protectors for bus bars that are connected to a plurality of paths, and it is possible to suppress an increase in manufacturing costs. Thus, it is possible to allow bus bars to be connected to a plurality of paths, while suppressing an increase in manufacturing costs.

The following are preferable modes in which the technology disclosed in the present description is carried out. The sub cover portion abuts against a bus bar. With this configuration, it is possible to reliably suppress degradation of insulation properties regarding a part against which the sub cover portion abuts.

The hinge portion is elastically deformable, and the sub cover portion biases a bus bar, using an elastic force generated by the hinge portion. With this configuration, it is possible to suppress degradation of insulation properties, using an elastic force generated by the hinge portion.

The path that is different from the path via which the aforementioned bus bar is led out extends along an outer surface of the electricity storage module, the outer surface being different from an electrode terminal-side outer surface of the electricity storage module. If the path of a bus bar is three-dimensional, a gap is likely to occur, from which the bus bar is exposed, and there is a concern that insulation properties will degrade. However, in such a configuration, due to the sub cover portion pivoting, it is possible to suppress degradation of insulation properties.

An electricity storage module including: the insulating protector; and the bus bars may be provided.

With the technology disclosed in the present description, it is possible to connect the bus bars to a plurality of paths, while suppressing an increase in manufacturing costs.

### BRIEF DESCRIPTION OF THE DRAWINGS

FIG. 1 is a partially-enlarged plan view of an electricity storage module according to a first embodiment in a state where a first bus bar is connected to an electrode terminal.

FIG. 2 is a partially-enlarged front view of the electricity storage module in a state where the first bus bar is connected to an electrode terminal.

FIG. 3 is a partially-enlarged left side view of the electricity storage module in a state where the first bus bar is connected to an electrode terminal.

FIG. 4 is a cross-sectional view along a line A-A in FIG. 1.

FIG. 5 is a plan view showing an electricity storage body.

FIG. 6 is a partially-enlarged front view of the electricity storage body.

FIG. 7 is a plan view showing a state in which the first bus bar is connected to an electrode terminal of the electricity storage body.

FIG. 8 is a front view showing a state in which the first bus bar is connected to an electrode terminal of the electricity storage body.

FIG. 9 is a left side view showing a state in which the first bus bar is connected to an electrode terminal of the electricity storage body.

FIG. 10 is a cross-sectional view along a line B-B in FIG. 7.

FIG. 11 is a plan view showing an insulating protector.

FIG. 12 is a front view showing an insulating protector.

FIG. 13 is a left side view showing an insulating protector.

FIG. 14 is a partially-enlarged plan view of the electricity storage module in a state where a second bus bar is connected to an electrode terminal.

FIG. 15 is a partially-enlarged front view of the electricity storage module in a state where the second bus bar is connected to an electrode terminal.

FIG. 16 is a partially-enlarged left side view of the electricity storage module in a state where the second bus bar is connected to an electrode terminal.

FIG. 17 is a cross-sectional view along a line C-C in FIG. 14.

FIG. 18 is a plan view showing a state in which the second bus bar is connected to an electrode terminal of the electricity storage body.

### DETAILED DESCRIPTION OF THE PREFERRED EMBODIMENTS

### First Embodiment

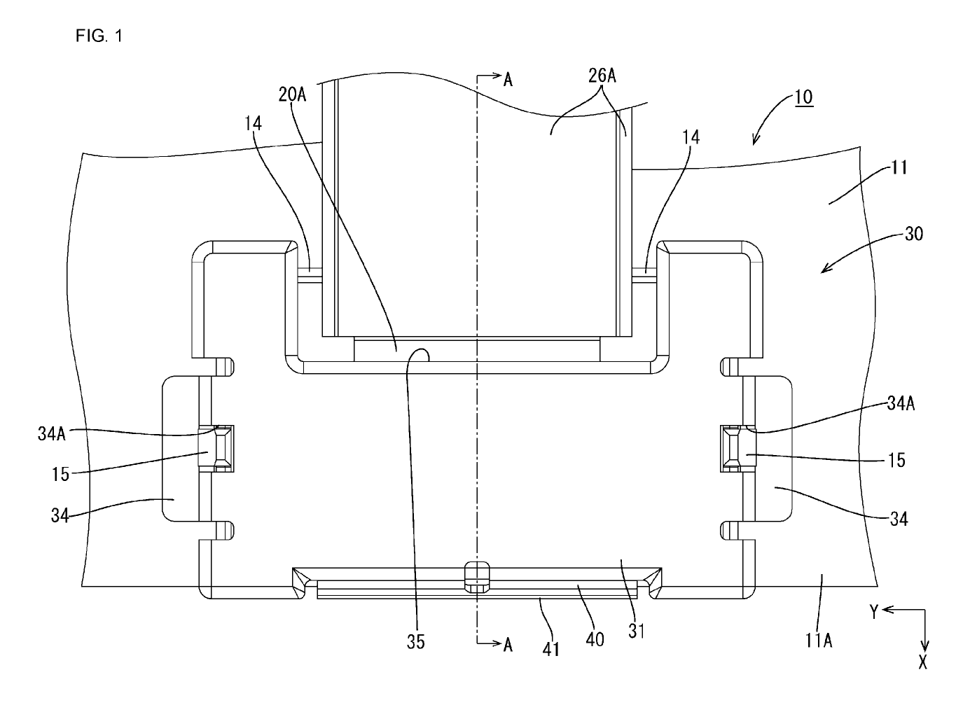

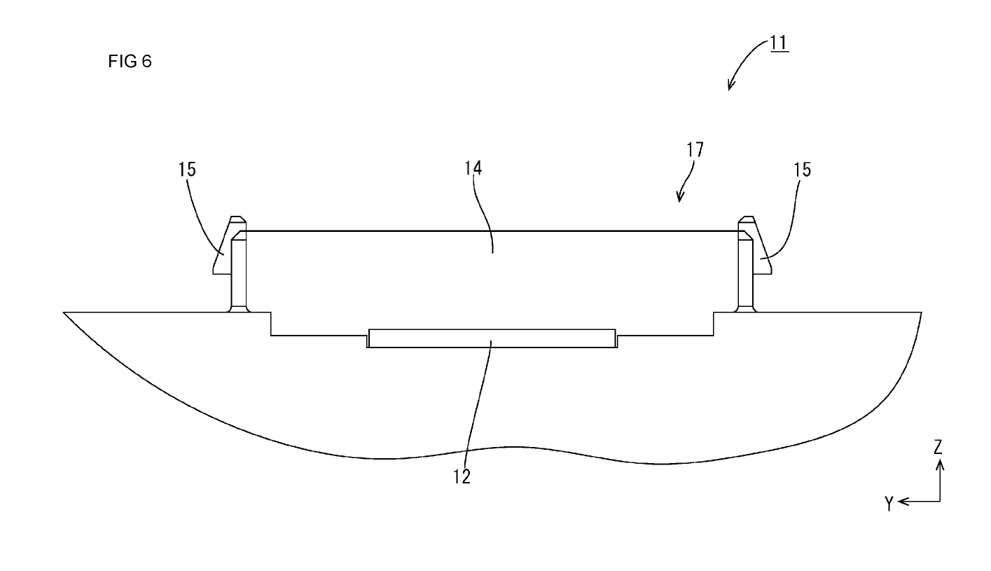

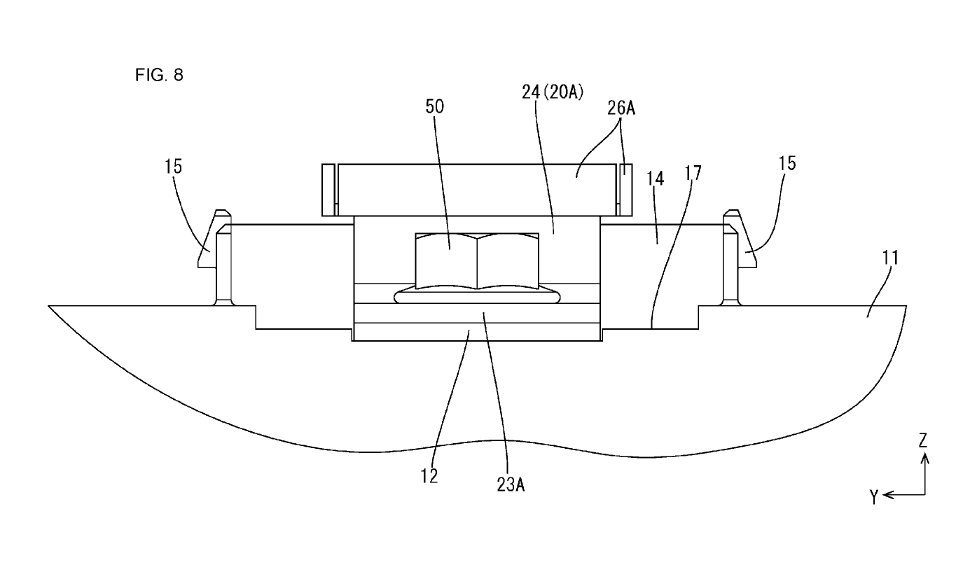

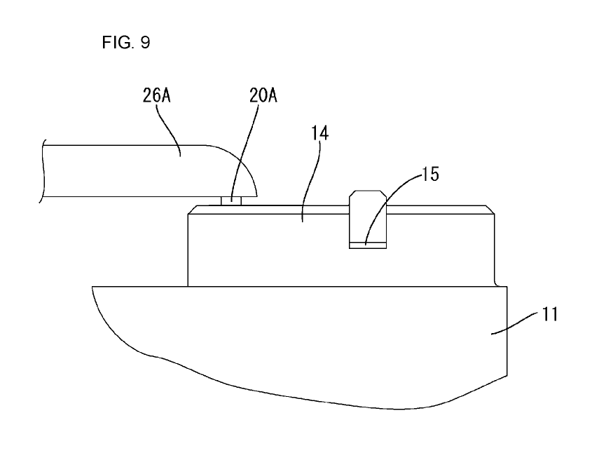

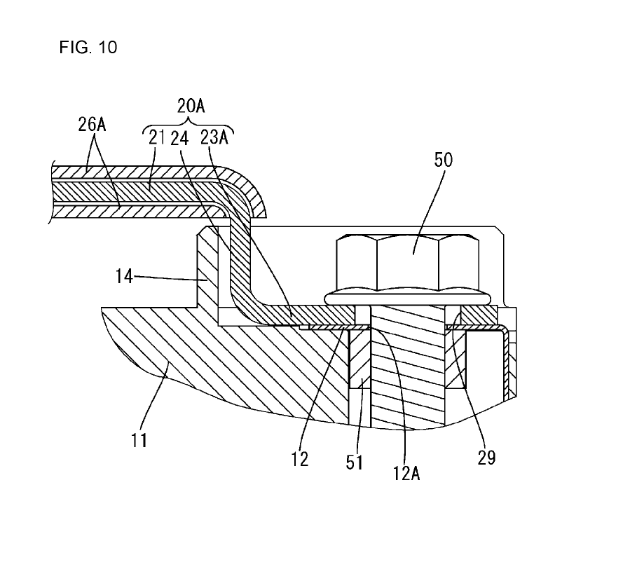

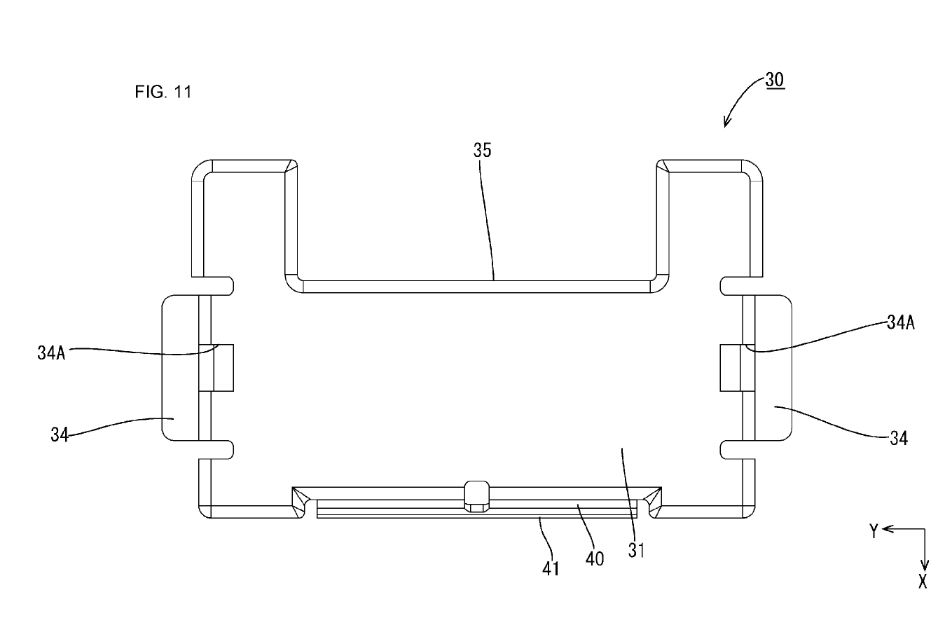

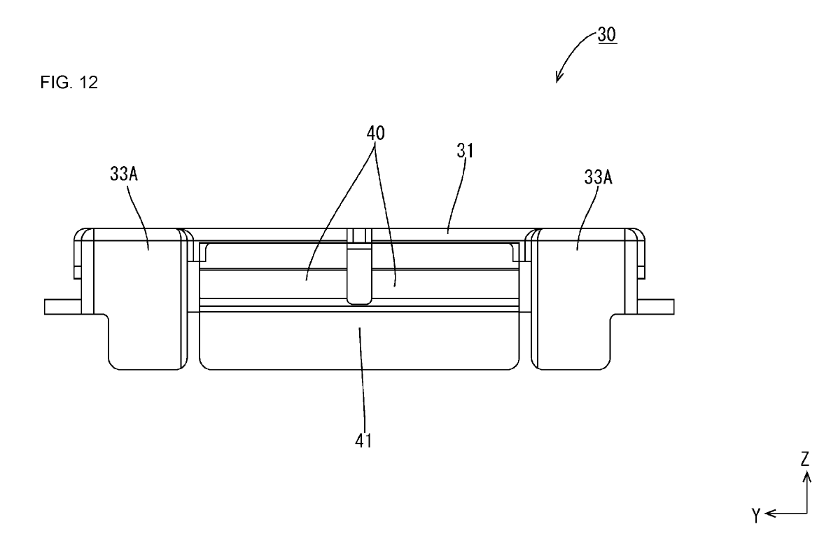

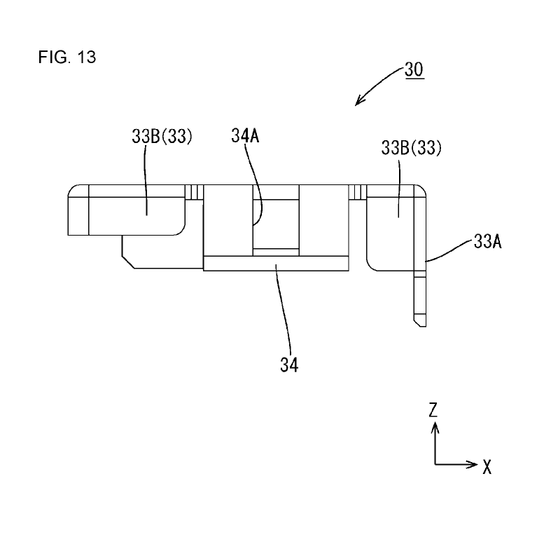

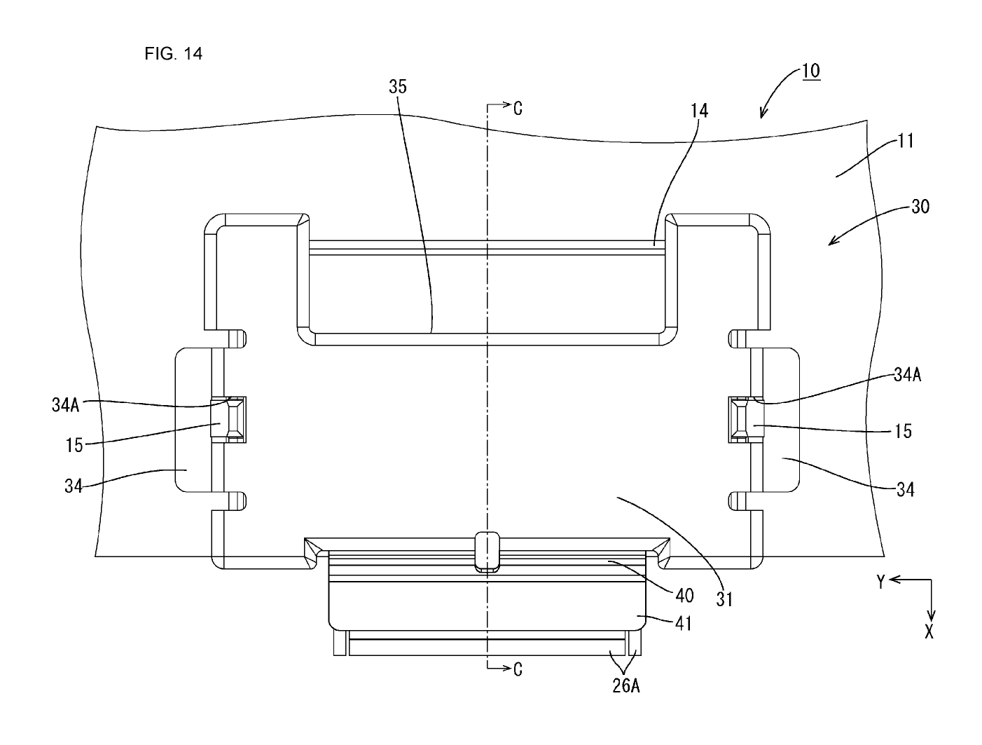

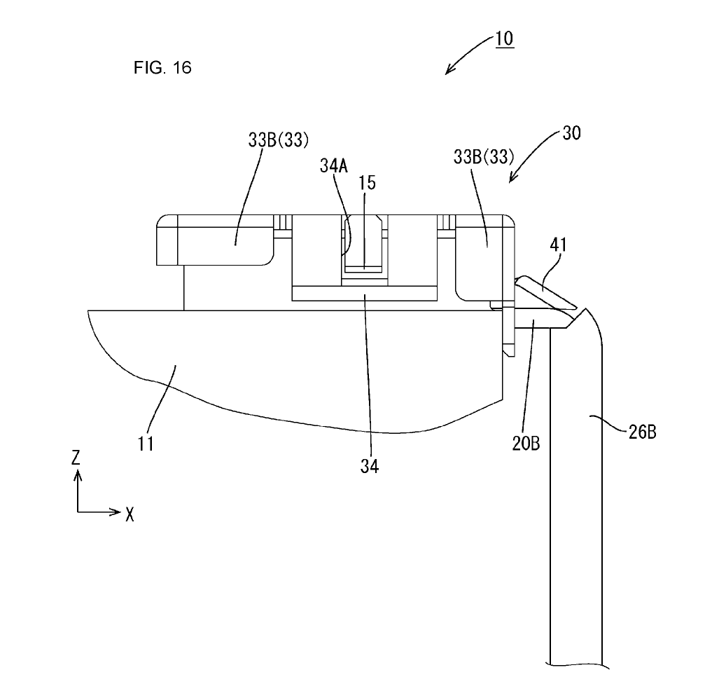

The following describes a first embodiment with reference to FIGS. 1 to 18. An electricity storage module 10 according to the present embodiment is mounted on a vehicle such as an electric vehicle or a hybrid vehicle, and is used as a power supply for driving the vehicle. In the following description, “X direction” indicates a forward direction, “Y direction” indicates a direction to the left, and “Z direction” indicates an upward direction.

Electricity Storage Module 10

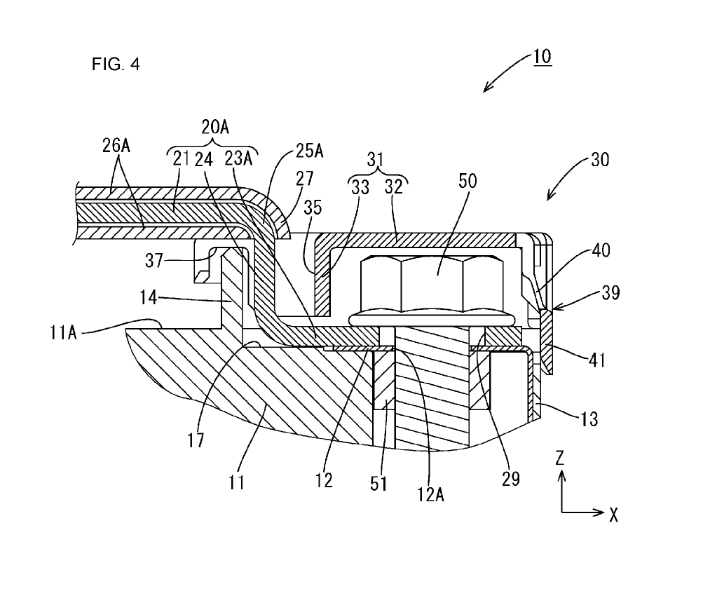

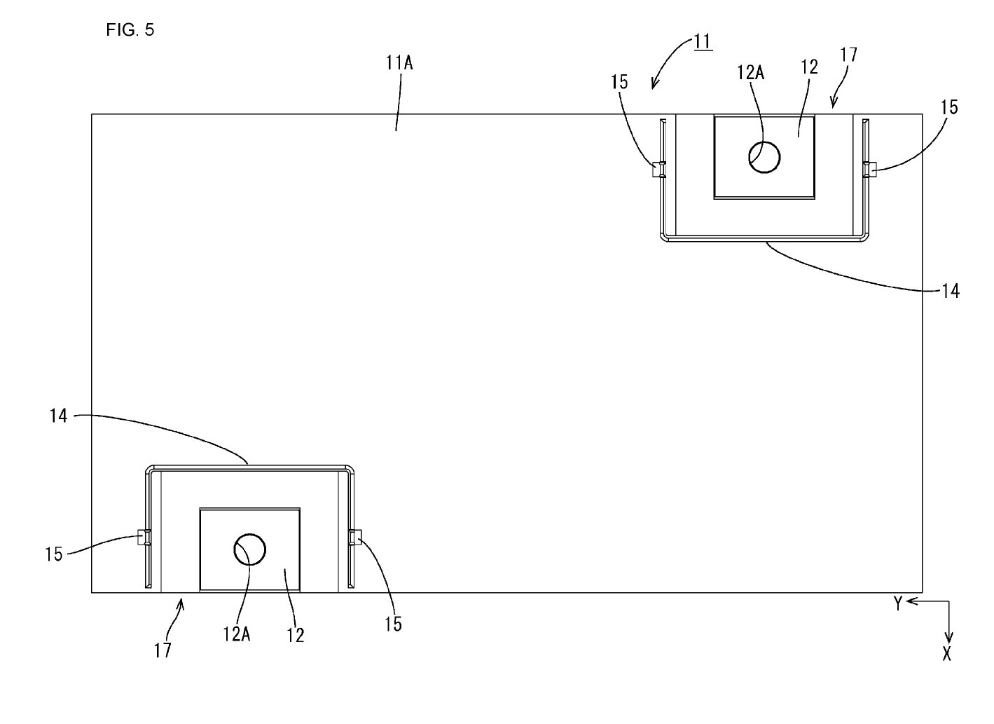

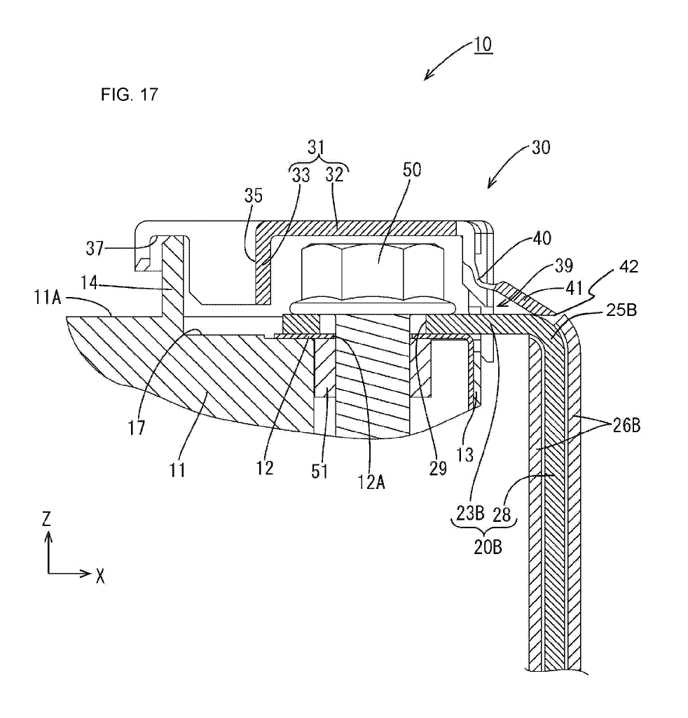

As shown in FIGS. 4 and 17, the electricity storage module 10 includes an electricity storage body 11 that has electrode terminals 12, a first bus bar 20A (an example of a “bus bar”) or a second bus bar 20B (an example of a “bus bar”) that is selectively connected to an electrode terminal 12, and insulating protectors 30 that are attached to the electricity storage body 11. The electricity storage body 11 is constituted by arranging a plurality of electricity storage elements (not shown) that each have positive and negative electrodes. The electrodes of electricity storage elements that are adjacent to each other are connected by a connection member that is made of metal, and thus the plurality of electricity storage elements are connected in series. Also, as shown in FIG. 5, for example, a pair of positive and negative electrode terminals 12 at the ends of the series connection are exposed from an upper surface 11A so as to be connectable to external elements.

Areas that are close to the electrode terminals 12, of the upper surface 11A of the electricity storage body 11 are configured as attachment parts 17 to which the insulating protectors 30 are attached. In each attachment part 17, a standing wall 14 that is insulative stands upright around an electrode terminal 12. The standing wall 14 extends so as to have a U-like shape to surround the electrode terminal 12, and claw-shaped locking parts 15 for locking an insulating protector 30 respectively protrude from the left and right outer surfaces of the standing wall 14. As shown in FIG. 4, each electrode terminal 12 has a connection surface that is parallel with the upper surface 11A of the electricity storage body 11. Each electrode terminal 12 is bent downward inside a front wall 13 of the electricity storage body 11 so as to have an L-like shape, and is connected to an internal electricity storage element. A circular through hole 12A, into which the shaft of a bolt 50 is inserted, is formed in each electrode terminal 12 so as to penetrate therethrough. A space into which the shaft part of a bolt 50 and a nut 51 can be inserted is formed below each electrode terminal 12.

First Bus Bar 20A and Second Bus Bar 20B

The first bus bar 20A and the second bus bar 20B are selectively connected to the electrode terminals 12 at the ends of the series connection, and both bus bars are plate-shaped members that each have a length corresponding to the position of a partner terminal that is provided on an external device (e.g. an inverter or a motor) or another electricity storage module, for example, and are made of metal such as copper, a copper alloy, aluminum, an aluminum alloy, or stainless steel (SUS). An electrode terminal 12—side portion of the first bus bar 20A is bent so as to have a crank-like shape, and the first bus bar 20A includes a bus bar body 21, which is elongated, a connection portion 23A that is provided at an end in the lengthwise direction and is placed on and connected to the upper surface of an electrode terminal 12, and a level-difference portion 24 by which the bus bar body 21 and the connection portion 23A are coupled to each other so as to form a step-like shape.

The bus bar body 21 is covered by a bus bar protector 26A that is made of an insulative synthetic resin. The bus bar protector 26A has a tubular shape that can be divided into an upper part and a lower part. The first bus bar 20A is inserted into the bus bar protector 26A, and includes a curved portion 27 that is curved so as to match the shape of the outer surface of a bent portion 25A that is bent between the bus bar body 21 and the level-difference portion 24. The lower end of the curved portion 27 (an end of the bus bar protector 26A) is located slightly below the upper surface of the insulating protector 30. When the connection portion 23A of the first bus bar 20A is connected to an electrode terminal 12, the first bus bar 20A extends along the upper surface 11A of the electricity storage body 11 toward the rear side of the electrode terminal 12. A circular through hole 29, into which the shaft of a bolt 50 is inserted, is formed in the connection portion 23A so as to penetrate therethrough.

As shown in FIG. 17, the second bus bar 20B includes a bus bar body 28, which is elongated, and a connection portion 23B that is bent from the bus bar body 28 so as to have an L-like shape, and is placed on and connected to the upper surface of an electrode terminal 12. The bus bar body 28 is covered by a bus bar protector 26B that is made of an insulative synthetic resin. The bus bar protector 26B has a tubular shape that can be divided into a front part and a rear part. The second bus bar 20B is inserted into the bus bar protector 26B, and the upper end of the bus bar protector 26B is located in the vicinity of a bent portion 25B that is bent between the bus bar body 28 and the connection portion 23B. A circular through hole 29, into which the shaft of a bolt 50 is inserted, is formed in the connection portion 23B so as to penetrate therethrough.

When the connection portion 23B of the second bus bar 20B is connected to an electrode terminal 12, the second bus bar 20B extends along the front surface of the electricity storage body 11 toward the front side of the electrode terminal 12. Note that a voltage detection terminal (not shown) for detecting the voltage across the electricity storage elements may be placed on the first bus bar 20A and the second bus bar 20B. An electrical wire connected to the voltage detection terminal is connected to an external ECU (Electronic Control Unit) (not shown). The ECU is equipped with a microcomputer, elements, etc., and has a well-known configuration that is provided with the functions of detecting the voltage, current, temperature, and so on of the electricity storage elements, and performing charging/discharging control on each electricity storage element.

Insulating Protectors 30

Each insulating protector 30 is made of an insulative synthetic resin, and includes a main cover portion 31 that covers an electrode terminal 12, and a sub cover portion 41 that is pivotable about a hinge portion 40 relative to the main cover portion 31. The main cover portion 31 has a box shape that covers an electrode terminal 12 and a bolt 50, and includes a top plate 32 that has a plate shape, and a partition wall 33 that protrudes from a peripheral portion of the top plate 32 toward the electricity storage module 10.

Main Cover Portion 31

A first lead-out portion 35 that allows the first bus bar 20A to be led out of an insulating protector 30 is formed in a rear portion of the main cover portion 31 of the insulating protector 30. The first lead-out portion 35 is formed in an intermediate portion, in a left-right direction, of the rear ends of the top plate 32 and the partition wall 33 so as to be recessed. When the insulating protector 30 is attached to the electricity storage body 11, the first bus bar 20A is located between the first lead-out portion 35 and the standing wall 14, at a position near the standing wall 14. A recessed portion 37 whose bottom surface side is recessed is formed in a rear end portion of the main cover portion 31. The upper end of the standing wall 14 abuts against the recessed portion 37, and thus the insulating protector 30 is held at a predetermined height.

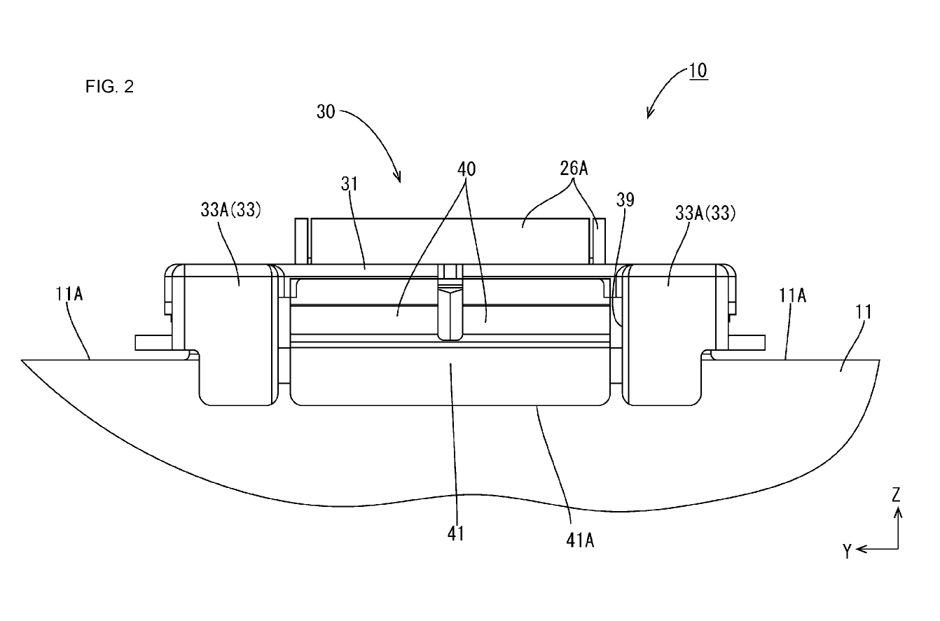

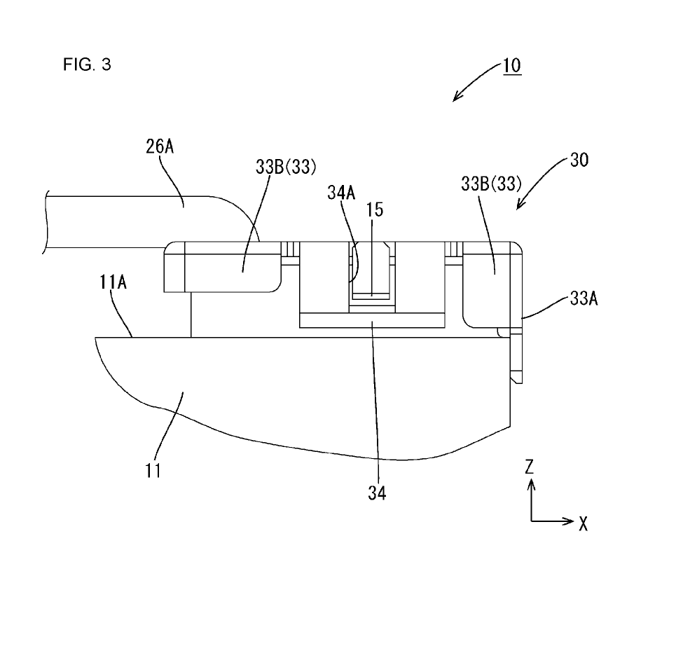

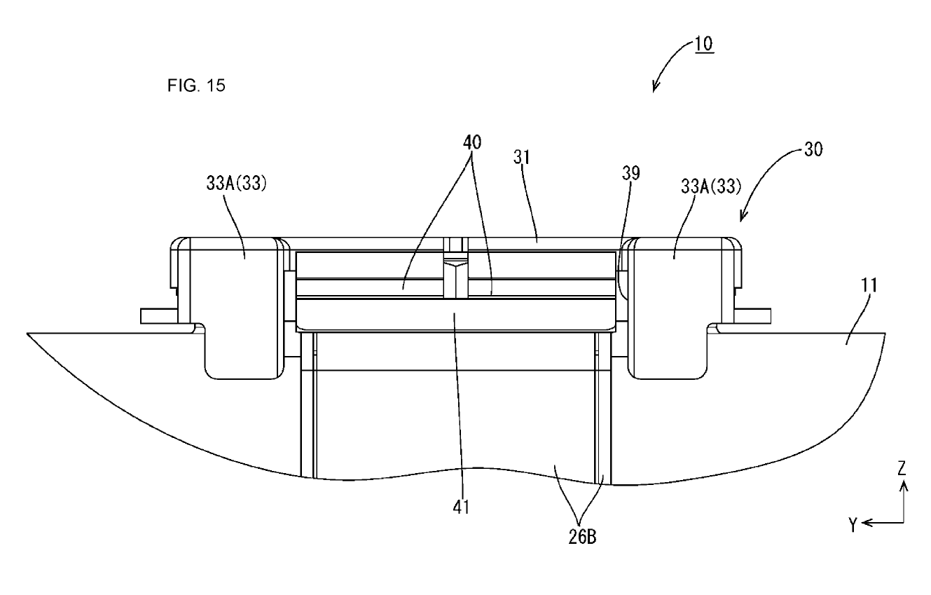

As shown in FIG. 15, a front wall portion 33A of the partition wall 33 is cut out, and thus a second lead-out portion 39 that allows the second bus bar 20B to be led out is formed. In a state where the sub cover portion 41 is closed, an opening that is formed by the second lead-out portion 39 and allows the second bus bar 20B to be led out is almost entirely covered by the sub cover portion 41 (see FIG. 2). As shown in FIG. 3, left and right side wall portions 33B of the partition wall 33 each have a lock-target part 34 that can bend and deform and is locked to a locking part 15 of a standing wall 14. Each lock-target part 34 has a frame shape in which a lock-target hole 34A is formed so as to penetrate therethrough, and each lock-target part 34 is formed by cutting out a side wall portion 33B.

When an insulating protector 30 is attached to an attachment part 17 of the electricity storage body 11, the upper end of the standing wall 14 abuts against the recessed portion 37 as shown in FIG. 4, and the lock-target parts 34 are locked to the locking parts 15. Thus, the position of the insulating protector 30 in the top-bottom direction is held within the range of a predetermined clearance. Also, an upper end portion of the standing wall 14 is held in the recessed portion 37, and thus the position of the insulating protector 30 in the front-rear direction is held. Also, the left and right side wall portions 33B are located opposite to each other outside the standing wall 14, and thus the position of the insulating protector 30 in the left-right direction is held.

Sub Cover Portion 41

As shown in FIG. 2, the sub cover portion 41 has a rectangular plate shape, and extends further downward compared to the side wall portions 33B, as with the front wall portion 33A. A lower end 41A of the sub cover portion 41 is located below the upper surface 11A of the electricity storage body 11. As shown in FIG. 17, a lower end portion of the sub cover portion 41 is configured as a taper portion 42 whose inner side (rear side) is cut out so that the taper portion 42 tapers. When the insulating protector 30 is attached, the tapered portion 42 abuts against the second bus bar 20B, and thus the sub cover portion 41 pivots to open forward.

The hinge portion 40 has a thin band-like shape, and is elastically deformable due to the thickness thereof. An intermediate portion of the hinge portion 40 in the left-right direction is cut out, and thus the hinge portion 40 is divided into a left part and a right part. In a natural state where the hinge portion 40 is not elastically deformed, the sub cover portion 41 has a shape that extends in the top-bottom direction. When the sub cover portion 41 is pivoted from such a state, the hinge portion 40 generates an elastic force in a direction in which the hinge portion 40 restores to the original shape thereof. Each insulating protector 30 can be formed by hardening resin that has been injected in a mold.

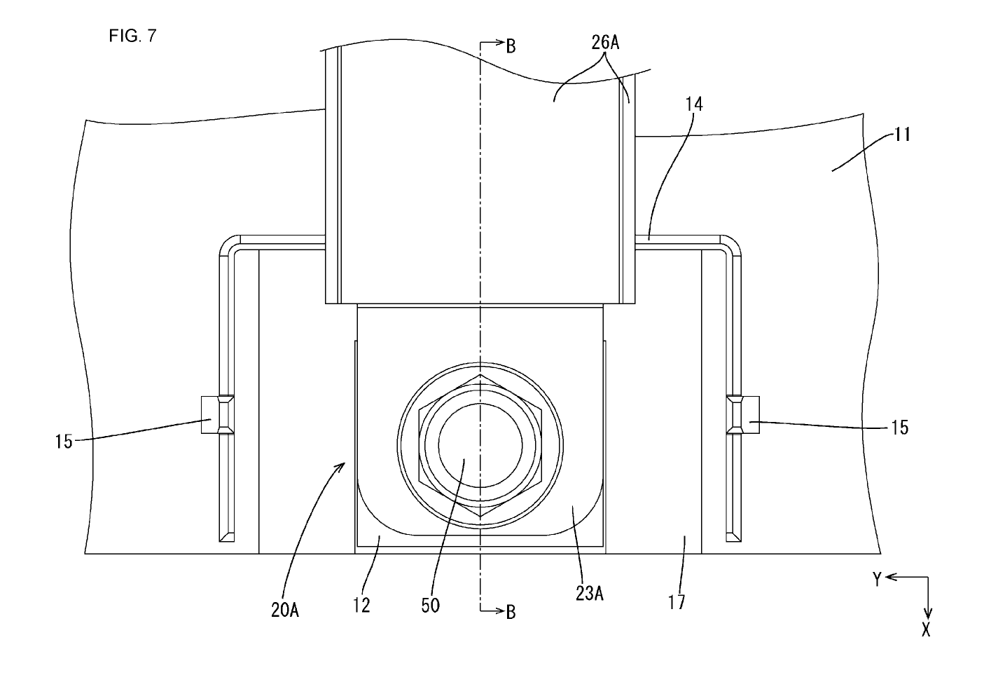

Next, attachment of the electricity storage module 10 will be described. A plurality of electricity storage elements are connected in series by connecting electrode terminals 12 that are adjacent to each other, of the plurality of electricity storage elements, using connection members. Then, one of the first bus bar 20A and the second bus bar 20B is connected to an electrode terminal 12, depending on the partner device or the like. In Cases where First Bus Bar 20A is Connected to Electrode Terminal 12. The bus bar body 21 is positioned rearward of an electrode terminal 12, the connection portion 23A of the first bus bar 20A is placed on the electrode terminal 12, and the connection portion 23A and the electrode terminal 12 are fastened to each other using a bolt (FIG. 7).

Next, when an insulating protector 30 is attached to the attachment part 17 from above, the lock-target parts 34 are locked to the locking parts 15. At this time, the first bus bar 20A is led out of the first lead-out portion 35, the sub cover portion 41 extends in a top-bottom direction and abuts against an upper end portion of the front surface of the body of the electricity storage module 10 to close the second lead-out portion 39 (FIG. 4).

In Cases where Second Bus Bar 20B is Connected to Electrode Terminal 12

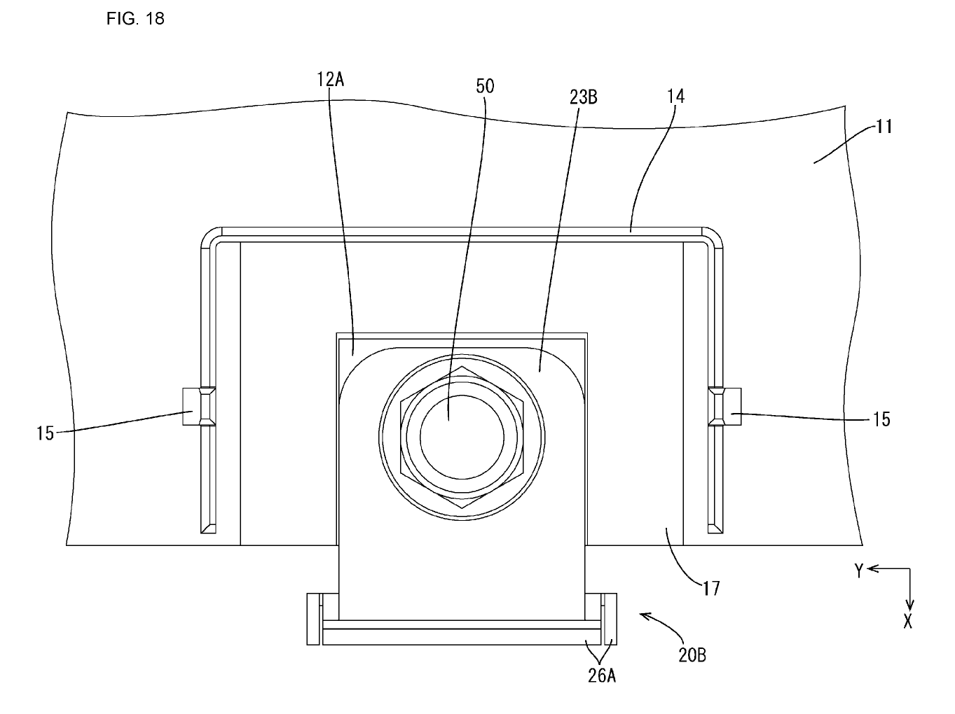

The bus bar body 28 is positioned forward of an electrode terminal 12, the connection portion 23B of the second bus bar 20B is placed on the electrode terminal 12, and the connection portion 23B and the electrode terminal 12 are fastened to each other using a bolt (FIG. 18).

Next, when an insulating protector 30 is attached to the attachment part 17 from above, the lock-target parts 34 are locked to the locking parts 15. At this time, the second bus bar 20B is led out of the second lead-out portion 39 and the sub cover portion 41 abuts against the second bus bar 20B, and the hinge portion 40 elastically deforms in a direction in which the sub cover portion 41 opens, while generating an elastic repulsive force (FIG. 17).

The present embodiment achieves the following actions and effects. An insulating protector 30 that is to be attached to an electricity storage module 10 that has positive and negative electrode terminals 12, the insulating protector 30 including: a main cover portion 31 that is configured to allow a first bus bar 20A (a bus bar) that is connected to an electrode terminal 12, to be led out, and to allow a second bus bar 20B (a bus bar) that is connected to an electrode terminal 12, to be led out via a path that is different from a path via which the first bus bar 20A is led out; and a sub cover portion 41 that is pivotable about a hinge portion 40 relative to the main cover portion 31, and covers the bus bar 20B.

According to the present embodiment, the sub cover portion 41 pivots about the hinge portion 40 relative to the main cover portion 31, and thus the sub cover portion 41 can cover the second bus bar 20B that is connected to an electrode terminal 12 via a path that is different from a path via which the first bus bar 20A is connected to an electrode terminal 12. With this configuration, there is no need to prepare different insulating protectors for the bus bars 20A and 20B that are connected to a plurality of paths, and therefore it is possible to suppress an increase in manufacturing costs. Thus, it is possible to allow the bus bars 20A and 20B to be connected to a plurality of paths, while suppressing an increase in manufacturing costs.

Also, the sub cover portion 41 abuts against the second bus bar 20B. With this configuration, it is possible to reliably suppress degradation of insulation properties regarding a part against which the sub cover portion 41 abuts.

Also, the hinge portion 40 is elastically deformable, and the sub cover portion 41 biases the second bus bar 20B, using an elastic force generated by the hinge portion 40. With this configuration, it is possible to suppress degradation of insulation properties, using an elastic force generated by the hinge portion 40.

Also, the path that is different from the path via which the bus bar 20B is led out extends along the front surface of the front wall 13 of the electricity storage module 10 (an outer surface that is different from the electrode terminal 12-side outer surface).

If the path of the bus bar 20B is three-dimensional, a gap is likely to occur, from which the bus bar 20B is exposed, and there is a concern that insulation properties degrade. However, in such a configuration, due to the sub cover portion 41 pivoting, it is possible to suppress degradation of insulation properties.

### Other Embodiments

The present description is not limited to the embodiment that has been described based on the descriptions above and the drawings. For example, the following embodiments are included in the technology described in the present description.

(1) Although the first bus bar 20A and the second bus bar 20B are described as being to be connected to the same electrode terminal 12, they may be connected to different electrode terminals 12.

(2) Although the first bus bar 20A and the second bus bar 20B are connected to the electrode terminals 12 so as to be orientated in opposite directions that are 180° different from each other, the present description is not limited to such a configuration. For example, the first bus bar 20A and the second bus bar 20B may be connected to the same electrode terminal 12 so as to form a given angle with each other, or connected to a plurality of different electrode terminals 12 such that the first bus bar 20A and the second bus bar 20B are parallel with each other.

(3) The shapes of the first bus bar 20A and the second bus bar 20B are not limited to the shapes described in the embodiment above, and may be variously modified. The shapes are not necessarily different from each other, and may be the same. Also, the first bus bar and the second bus bar are not necessarily separate members, and may be realized using a shared member.

(4) In the embodiment above, the first bus bar 20A and the second bus bar 20B are fastened using a bolt 50 and a nut 51 that serve as fastening members. However, the present description is not limited to such a configuration. For example, the bus bars may be connected to the electrode terminal 12 through laser welding, ultrasonic welding, resistance welding, or the like.

(5) in the embodiment above, there is only one sub cover portion 41. However, a plurality of sub cover portions 41 may be provided. For example, the first lead-out portion 35 may also be provided with a sub cover portion 41.

(6) The insulating protectors 30 insulate not only the upper surface sides of both the first bus bar 20A and the second bus bar 20B, but also the lower surface side thereof. For example, the insulating protectors 30 may each be provided with an insulative mounting portion on which the first bus bar 20A or the second bus bar 20B are mounted.

(7) The electricity storage elements are not necessarily batteries, and may be capacitors or the like.

### List of Reference Numerals

10: Electricity Storage Module

12: Electrode Terminal

20A: First Bus Bar (Bus Bar)

20B: Second Bus Bar (Bus Bar)

30: Insulating protector

31: Main Cover Portion

35: First Lead-out Portion

39: Second Lead-out Portion

40: Hinge Portion

41: Sub Cover Portion

1. An insulating protector that is to be attached to an electricity storage module that has positive and negative electrode terminals, the insulating protector comprising:
a main cover portion that is configured to allow a bus bar that is connected to an electrode terminal, to be led out, and to allow a bus bar that is connected to an electrode terminal, to be led out via a path that is different from a path via which the aforementioned bus bar is led out; and
a sub cover that is pivotable about a hinge portion relative to the main cover portion, and covers a bus bar.

2. The insulating protector according to claim 1, wherein the sub cover portion abuts against a bus bar.

3. The insulating protector according to claim 1, wherein the hinge portion is elastically deformable, and the sub cover portion biases a bus bar, using an elastic force generated by the hinge portion.

4. The insulating protector according to claim 1, wherein the path that is different from the path via which the aforementioned bus bar is led out extends along an outer surface of the electricity storage module, the outer surface being different from an electrode terminal-side outer surface of the electricity storage module.

5. An electricity storage module comprising: the insulating protector according to claim 1; and the bus bars.
